(19) United States
(12) Patent Application Publication
(10) Pub. No.: US 2026/0189499 A1
(43) Pub. Date: Jul. 2, 2026

(54) INFORMATION PROCESSING SYSTEM

(71) Applicant: NIPPON TELEGRAPH AND TELEPHONE CORPORATION, Tokyo (JP)

(72) Inventors: Kenji Tanaka, Tokyo (JP); Yuki Arikawa, Tokyo (JP); Tsuyoshi Ito, Tokyo (JP); Naoki Miura, Tokyo (JP); Takeshi Sakamoto, Tokyo (JP); Yusuke Muranaka, Tokyo (JP)

(21) Appl. No.: 18/857,140

(22) PCT Filed: Jun. 1, 2022
(86) PCT No.: PCT/JP2022/022287

§ 371 Date: Oct. 15, 2024

(51) Int. Cl. H04L 45/00; H04L 43/0876; H04L 45/745

(52) U.S. Cl. CPC H04L 45/34; H04L 43/0876; H04L 45/745

(57) ABSTRACT

A management unit sets a first rule defining a feature to be used for classification of a packet arriving from a client terminal and a transfer destination of the packet for each arrival frequency of the packet to a classifier of a network interface card. The first rule is set in such a manner that the ratio of a packet to be sent to the CPU increases as an arrival frequency of the packet decreases. A classifier measures an arrival frequency of a packet for each feature of the packet, and determines a transfer destination of the packet received from the client terminal according to the first rule corresponding to an arrival frequency of a packet having the same feature as a feature of the packet received from the client terminal.

### CROSS-REFERENCE TO RELATED APPLICATIONS

This application is a national phase entry of PCT Application No. PCT/JP2022/022287, filed on Jun. 1, 2022, which application is hereby incorporated herein by reference.

### TECHNICAL FIELD

The present invention relates to an information processing system that performs at least part of packet processing with a network interface card.

### BACKGROUND

Conventionally, a main part of a computer in a data center is a central processing unit (CPU), but with an increase in performance of communication, there are many cases where a network interface card (NIC) takes over communication and related information processing (encryption, compression, decryption, or the like) (see Non Patent Literature 1). The setting of this takeover (offloading) is performed by the CPU before execution of an application and cannot be changed until the application is terminated.

FIG. 4 is a block diagram illustrating a configuration of an information processing system without offloading. The packet transmitted from a client terminal 100 via a network 103 is transmitted to a CPU 102 via an NIC 101. Reference numeral 104 in FIG. 4 denotes a PCI Express (PCIe) bus that connects the CPU 102 and the NIC 101.

The CPU 102 extracts data from the received packet by a function of a network software stack 1020 mounted on an operating system (OS). Then, the CPU 102 executes processing of the data according to application software 1021, and returns a packet including the processed data to the client terminal 100 via the network software stack 1020.

FIG. 5 is a block diagram illustrating a configuration of an information processing system in which a part of functions of a CPU is processed by an NIC. The NIC 101 extracts data from a packet transmitted from the client terminal 100 via the network 103 by a function of a network software stack 1010 mounted on hardware. In addition, the NIC 101 executes all or part of the processing of the application software 1021 by a function unit 1011 mounted on hardware.

It is possible to process the data in the packet by the function unit 1011 and return the packet including the processed data to the client terminal 100. Alternatively, a packet including processed data can be sent to the CPU 102. The CPU 102 executes communication with the function unit 1011 according to the application software 1021, and manages initial setting and the like of the function unit 1011.

As described above, it is possible to cause the NIC 101 to process at least a part of the functions of the CPU 102, but in the hardware offloading configuration as illustrated in FIG. 5, setting of the offloading cannot be changed during execution of an application. Thus, even when the frequency at which the data processing is executed is low, the hardware offloading cannot be disabled.

Modern CPUs have extremely high power efficiency when performing infrequent processing, and if the frequency of processing is low, disabling hardware offloading provides better power efficiency. However, in the conventional configuration, there is a problem that it is not possible to improve power efficiency by disabling hardware offloading when the frequency of processing is low during execution of an application.

### CITATION LIST

### Non Patent Literature

Non Patent Literature 1: Yuta Tokusashi, et al., “The Case For In-Network Computing On Demand”, EuroSys '19: Proceedings of the Fourteenth EuroSys Conference 2019

### SUMMARY

### Technical Problem

The present invention has been made to solve the above problems, and an object thereof is to provide an information processing system capable of improving power efficiency.

### Solution to Problem

An information processing system according to the present invention includes a server on which a CPU that processes a packet and a network interface card are mounted, and a management unit configured to set the network interface card, in which the network interface card includes a classifier configured to classify and transfer a packet received from a client terminal according to a first rule, a function unit configured to execute predetermined processing on the packet transferred from the classifier, and a router configured to determine a transfer destination of the packet transferred from the function unit or the CPU according to a second rule, and transfer the packet to the determined transfer destination, the management unit sets, to the classifier, the first rule defining a feature to be used for classification of a packet arriving from the client terminal and a transfer destination of the packet classified on the basis of the feature for each arrival frequency of the packet, the first rule is set in such a manner that a ratio of a packet to be sent to the CPU increases as an arrival frequency of the packet decreases, and the classifier measures an arrival frequency of a packet for each feature of the packet, determines a transfer destination of the packet received from the client terminal according to the first rule corresponding to an arrival frequency of a packet having the same feature as a feature of the packet received from the client terminal, and transfers the packet to the determined transfer destination.

### Advantageous Effects of Invention

According to the present invention, a first rule is set in such a manner that a ratio of a packet to be sent to the CPU increases as an arrival frequency of the packet decreases, and a classifier determines a transfer destination of the packet received from the client terminal according to the first rule corresponding to an arrival frequency of a packet having the same feature as a feature of the packet received from the client terminal, whereby offloading can be adjusted in such a manner that the ratio of the packet to be sent to the CPU increases as the arrival frequency of the packet decreases, so that the power efficiency can be optimized.

### BRIEF DESCRIPTION OF THE DRAWINGS

FIG. 1 is a block diagram illustrating a configuration of an information processing system according to a first embodiment of the present invention.

FIG. 2 is a block diagram illustrating a configuration of an information processing system according to a second embodiment of the present invention.

FIG. 3 is a block diagram illustrating a configuration example of a computer that implements the information processing systems according to first and second embodiments of the present invention.

FIG. 4 is a block diagram illustrating a configuration of a conventional information processing system.

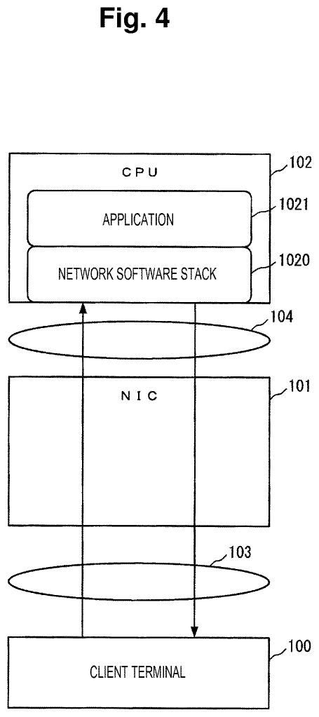

FIG. 5 is a block diagram illustrating another configuration of a conventional information processing system.

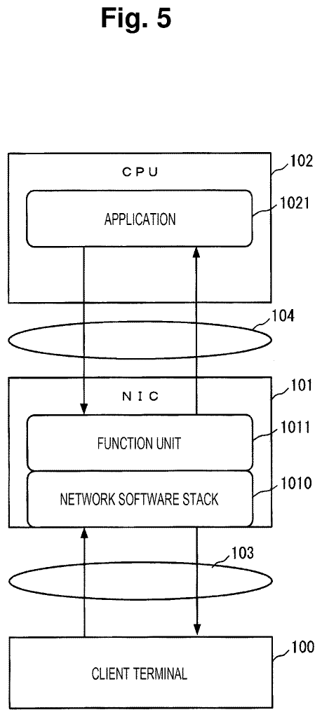

### DETAILED DESCRIPTION OF ILLUSTRATIVE EMBODIMENTS

### First Embodiment

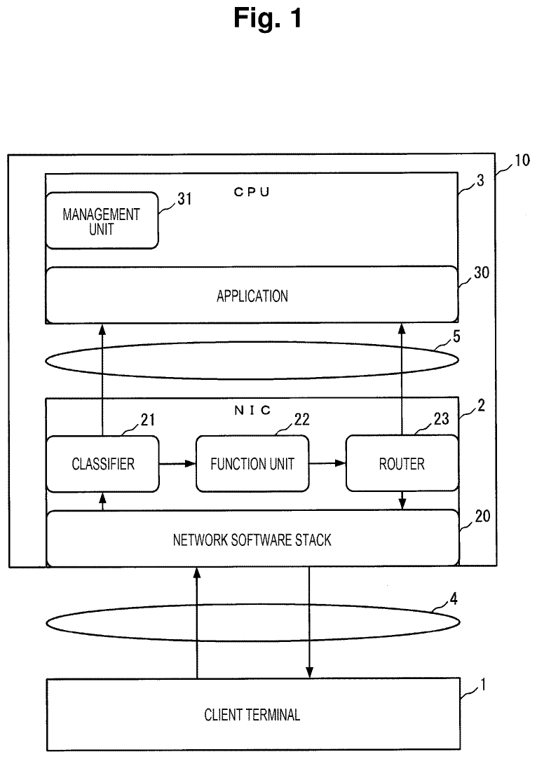

Hereinafter, embodiments of the present invention will be described with reference to the drawings. FIG. 1 is a block diagram illustrating a configuration of an information processing system according to a first embodiment of the present invention. The information processing system includes a client terminal 1, a network interface card (NIC) 2, and a CPU 3. In FIG. 1, reference numeral 4 denotes a network that connects the NIC 2 and the client terminal 1, and reference numeral 5 denotes a PCIe bus that connects the CPU 3 and the NIC 2. The NIC 2 and the CPU 3 are mounted on a server 10 of a data center connected to the client terminal 1 via the network 4.

The NIC 2 includes a network software stack 20, a classifier 21, a function unit 22, and a router 23.

In the present embodiment, by mounting the configuration as illustrated in FIG. 1 on the hardware of the NIC 2, it is possible to dynamically perform hardware offloading in accordance with an arrival frequency of a packet during execution of an application.

The classifier 21 classifies a packet transmitted from the client terminal 1 on the basis of features of the packet, and transfers the packet to either the CPU 3 or the function unit 22. The classifier 21 constantly measures the arrival frequency of the packet for each feature of the packet, and determines the transfer destination of the packet received from the client terminal 1 according to a classification rule corresponding to the arrival frequency of a packet having the same feature as the feature of the packet received from the client terminal 1. The classifier 21 can communicate with the CPU 3. The CPU 3 performs management such as rule setting for packet classification.

The function unit 22 executes predetermined processing on data stored in a payload of the packet transferred from the classifier 21.

The router 23 determines the transfer destination of the packet transferred from the function unit 22 or the CPU 3 on the basis of the features of the packet, and transfers the packet to either the CPU 3 or the client terminal 1. The router 23 can communicate with the CPU 3. The CPU 3 performs management such as rule setting for packet routing.

Hereinafter, the operation of the information processing system of the present embodiment will be described. The CPU 3 functions as a management unit 31 according to preset software. The management unit 31 sets, for the classifier 21 of the NIC 2, a classification rule defining a feature to be used for classification of a packet that has arrived at the NIC 2 from the client terminal 1 and a transfer destination (the CPU 3 or the function unit 22) of the packet classified on the basis of the feature for each arrival frequency of the packet. Further, the management unit 31 sets, in the router 23 of the NIC 2, a routing rule defining a feature to be used for routing the packet transferred from the function unit 22 or the CPU 3 and a transfer destination (the CPU 3 or the client terminal 1) of the packet.

The client terminal 1 sends a packet that the user desires to process to the network 4. The classifier 21 of the NIC 2 classifies the packet transmitted from the client terminal 1 according to the classification rule set by the management unit 31, and transfers the packet to either the CPU 3 or the function unit 22. Examples of the feature used for packet classification include transmission source information included in the header of the packet. The classification rule is set in such a manner that the ratio of the packet to be sent to the CPU 3 increases as the arrival frequency of the packets decreases.

The classifier 21 constantly measures the arrival frequency of the packet for each feature of the packet defined by the classification rule, and determines the transfer destination of the packet received from the client terminal 1 according to the classification rule corresponding to the arrival frequency of a packet having the same feature as the feature of the packet received from the client terminal 1. The classifier 21 writes information of the determined transfer destination as destination information of the header of the packet, and sends out the packet toward the transfer destination (the CPU 3 or the function unit 22).

The function unit 22 of the NIC 2 executes predetermined processing on data stored in the payload of the packet transferred from the classifier 21. The function unit 22 combines the header of the packet transferred from the classifier 21 and a payload storing the processed data into a packet, and transfers the packet to the router 23.

On the other hand, the CPU 3 executes processing on the data stored in the payload of the packet transferred from the classifier 21 according to application software 30. The CPU 3 combines the header of the packet transferred from the classifier 21 and a payload storing the processed data into a packet, and returns the packet to the NIC 2.

The router 23 of the NIC 2 determines the transfer destination (the CPU 3 or the client terminal 1) of the packet transferred from the function unit 22 or the CPU 3 according to the routing rule set from the management unit 31. Examples of the feature used for routing the packet include transmission source information included in the header of the packet as described above, or the like. The router 23 writes information of the determined transfer destination as destination information of the header of the packet, and sends out the packet toward the transfer destination (the CPU 3 or the client terminal 1).

As described above, in the present embodiment, the offloading can be adjusted in accordance with the arrival frequency of the packet, specifically, the offloading can be adjusted so that the ratio of the packet to be sent to the CPU 3 increases as the arrival frequency of the packet decreases, so that the power efficiency can be optimized.

It is sufficient if the classifier 21 classifies the packet by focusing on information such as a transmission source Internet Protocol (IP) address and a transmission source port number included in the header of the packet. Thus, since the position and size of the feature of the packet extracted by the classifier 21 are fixed, the circuit scale of the classifier 21 can be reduced, and the throughput and the power efficiency can be improved.

### Second Embodiment

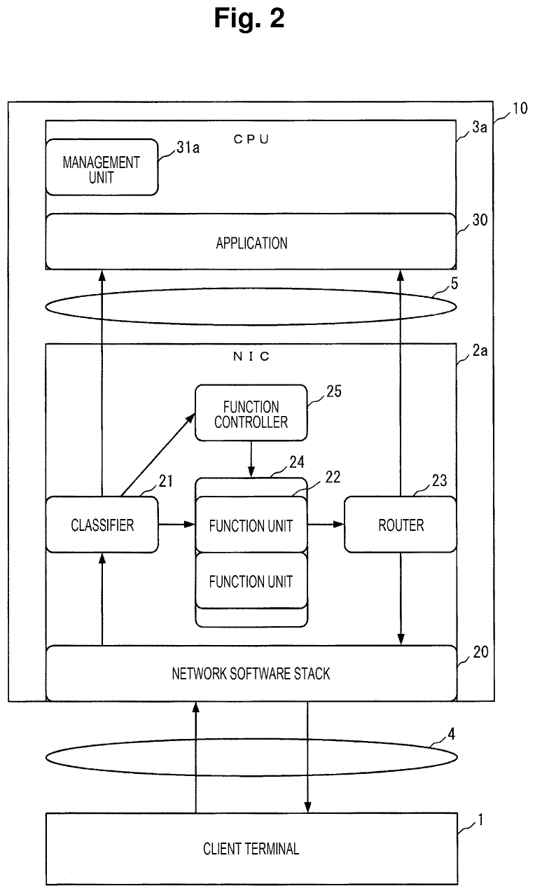

Next, a second embodiment of the present invention will be described. FIG. 2 is a block diagram illustrating a configuration of an information processing system according to a second embodiment of the present invention, and the same components as those in FIG. 1 are denoted by the same reference numerals. The information processing system of the present embodiment includes the client terminal 1, an NIC 2a, and a CPU 3a. As in the first embodiment, the NIC 2a and the CPU 3a are mounted on the server 10 of the data center connected to the client terminal 1 via the network 4.

The NIC 2a includes the network software stack 20, the classifier 21, the router 23, a partial reconfiguration region 24, and a function controller 25.

In the present embodiment, by mounting the configuration as illustrated in FIG. 2 on the hardware of the NIC 2a, it is possible to dynamically perform hardware offloading in accordance with the arrival frequency of the packet during execution of an application.

In the present embodiment, the function unit 22 is arranged in a partial reconfiguration region 24. A plurality of function units 22 can be arranged in the partial reconfiguration region 24. The function unit 22 can perform writing and erasing at any timing.

The CPU 3a functions as the management unit 31a according to preset software. The management unit 31a sets a reconfiguration rule defining bit stream data for reconfiguration of the function unit 22 and the number of function units 22 to be arranged in the function controller 25 of the NIC 2a for each feature of the packet and each arrival frequency.

The function controller 25 refers to the reconfiguration rule corresponding to the feature of the packet received by the classifier 21 and the arrival frequency of the packet having the same feature as the feature of the received packet. Then, the function controller 25 changes the configuration of the partial reconfiguration region 24 so that the function unit 22 defined by the reconfiguration rule is arranged in the partial reconfiguration region 24. The function controller 25 can rewrite the partial reconfiguration region 24 with bit stream data for reconfiguration.

The operation of other configurations is similar to that of the first embodiment. In the present embodiment, the reconfiguration rule is set so that the number of function units 22 that process the packet increases as the arrival frequency of the packet increases. Thus, when a high load is applied, parallel processing by the plurality of function units 22 becomes possible, so that the power efficiency can be improved. Furthermore, in the present embodiment, different types of function units 22 can be appropriately managed according to settings from the management unit 31a.

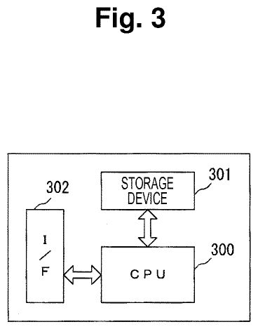

Each of the server, the NICs 2 and 2a, and the client terminal 1 described in the first and second embodiments can be implemented by a computer including a CPU, a storage device, and an interface, and a program for controlling these hardware resources. A configuration example of this computer is illustrated in FIG. 3.

The computer includes a CPU 300, a storage device 301, and an interface device 302. In such a computer, a program implementing a method according to the present invention is stored in the storage device 301. The CPU 300 of each device executes the processing described in the first and second embodiments according to the program stored in the storage device 301. Note that a hardware part of the NICs 2 and 2a is configured by, for example, a field-programmable gate array (FPGA).

Some or all of the above embodiments may be described as the following supplementary notes, but are not limited to the following.

(Supplementary Note 1) An information processing system according to the present invention includes a server on which a CPU that processes a packet and a network interface card are mounted, and a management unit configured to set the network interface card, in which the network interface card includes a classifier configured to classify and transfer a packet received from a client terminal according to a first rule, a function unit configured to execute predetermined processing on the packet transferred from the classifier, and a router configured to determine a transfer destination of the packet transferred from the function unit or the CPU according to a second rule, and transfer the packet to the determined transfer destination, the management unit sets, to the classifier, the first rule defining a feature to be used for classification of a packet arriving from the client terminal and a transfer destination of the packet classified on the basis of the feature for each arrival frequency of the packet, the first rule is set in such a manner that a ratio of a packet to be sent to the CPU increases as an arrival frequency of the packet decreases, and the classifier measures an arrival frequency of a packet for each feature of the packet, determines a transfer destination of the packet received from the client terminal according to the first rule corresponding to an arrival frequency of a packet having the same feature as a feature of the packet received from the client terminal, and transfers the packet to the determined transfer destination.

(Supplementary Note 2) In the information processing system according to Supplementary Note 1, the feature of the packet is transmission source information included in a header of the packet.

(Supplementary Note 3) In the information processing system according to Supplementary Note 1, the management unit sets, in the router, the second rule defining a feature to be used for routing a packet transferred from the function unit or the CPU and a transfer destination of the packet.

(Supplementary Note 4) The information processing system according to any one of Supplementary Notes 1 to 3, in which the network interface card further includes a function controller for reconfiguration of the function unit, the management unit sets a third rule defining data for reconfiguration of the function unit and a number of function units to be arranged in the function controller for each feature of the packet and each arrival frequency, and the function controller refers to the third rule corresponding to a feature of the packet received by the classifier and an arrival frequency of a packet having the same feature as the feature of the received packet, and changes a configuration of a partial reconfiguration region of the network interface card in such a manner that the function unit defined by the third rule is arranged.

(Supplementary Note 5) In the information processing system according to Supplementary Note 4, the third rule is set in such a manner that the number of the function units that process the packet increases as the arrival frequency of the packet increases.

### INDUSTRIAL APPLICABILITY

The present invention can be applied to a technology of processing a packet using an NIC.

### REFERENCE SIGNS LIST

1 Client terminal
2, 2a Network interface card
3,3a CPU
4 Network
5 PCIe bus
10 Server
20 Network software stack
21 Classifier
22 Function unit
23 Router
24 Partial reconfiguration region
25 Function controller
30 Application software
31, 31a Management unit

1-5. (canceled)

6. An information processing system, comprising:
a server on which a central processing unit (CPU) and a network interface card are mounted; and
a management unit configured to set the network interface card,
wherein the network interface card includes:
a classifier configured to classify and determine a first transfer destination of a packet received from a client terminal according to a first rule, and transfer the packet to the first transfer destination;
a function circuit configured to execute predetermined processing on the packet transferred from the classifier; and
a router configured to determine a second transfer destination of the packet transferred from the function circuit or the CPU according to a second rule, and transfer the packet to the second transfer destination,
wherein the management unit is configured to set, on the classifier, the first rule defining a first feature for classification of the packet and the first transfer destination of the packet based on the first feature and an arrival frequency of one or more packets having the first feature,
wherein the first rule is set in such a manner that a ratio of the one or more packets having the first feature to be sent to the CPU increases as an arrival frequency of the one or more packets having the first feature decreases, and
wherein the classifier is further configured to measure an arrival frequency of respective packets for each feature of a plurality of features.

7. The information processing system according to claim 6, wherein
the first feature is transmission source information included in a header of the packet.

8. The information processing system according to claim 7, wherein:
the network interface card further includes a function controller for reconfiguration of the function circuit;
the management unit is configured to set a third rule defining data for reconfiguration of the function circuit and a number of function circuits to be arranged in the function controller for each feature of the plurality of features and an arrival frequency corresponding to each feature of the plurality of features; and
the function controller refers to the third rule corresponding to the first feature of the packet received by the classifier and the arrival frequency of the one or more packets having the first feature, and changes a configuration of a partial reconfiguration region of the network interface card in such a manner that the function circuit defined by the third rule is arranged.

9. The information processing system according to claim 8, wherein
the third rule is set in such a manner that a number of the function circuits that process the one or more packets having the first feature increases as the arrival frequency of the one or more packets increases.

10. The information processing system according to claim 6, wherein
the management unit is further configured to set, in the router, the second rule defining a second feature to be used for routing the packet transferred from the function circuit or the CPU and the second transfer destination of the packet.

11. The information processing system according to claim 10, wherein:
the network interface card further includes a function controller for reconfiguration of the function circuit;
the management unit is configured to set a third rule defining data for reconfiguration of the function circuit and a number of function circuits to be arranged in the function controller for each feature of the plurality of features and an arrival frequency corresponding to each feature of the plurality of features; and
the function controller refers to the third rule corresponding to the first feature of the packet received by the classifier and the arrival frequency of the one or more packets having the first feature, and changes a configuration of a partial reconfiguration region of the network interface card in such a manner that the function circuit defined by the third rule is arranged.

12. The information processing system according to claim 11, wherein
the third rule is set in such a manner that a number of the function circuits that process the one or more packets having the first feature increases as the arrival frequency of the one or more packets increases.

13. The information processing system according to claim 6, wherein:
the network interface card further includes a function controller for reconfiguration of the function circuit;
the management unit is configured to set a third rule defining data for reconfiguration of the function circuit and a number of function circuits to be arranged in the function controller for each feature of the plurality of features and an arrival frequency corresponding to each feature of the plurality of features; and
the function controller refers to the third rule corresponding to the first feature of the packet received by the classifier and the arrival frequency of the one or more packets having the first feature, and changes a configuration of a partial reconfiguration region of the network interface card in such a manner that the function circuit defined by the third rule is arranged.

14. The information processing system according to claim 13, wherein
the third rule is set in such a manner that a number of the function circuits that process the one or more packets having the first feature increases as the arrival frequency of the one or more packets increases.

15. An information processing system, comprising:
a server on which a central processing unit (CPU) and a network interface card are mounted; and
a management unit configured to set the network interface card,
wherein the network interface card includes:
a classifier configured to classify and determine a first transfer destination of a packet received from a client terminal according to a first rule, and transfer the packet to the first transfer destination;
a function circuit configured to execute predetermined processing on the packet transferred from the classifier; and
a router configured to determine a second transfer destination of the packet transferred from the function circuit or the CPU according to a second rule, and transfer the packet to the second transfer destination,
wherein the management unit is configured to set, to the classifier, the first rule defining a first feature for classification of the packet from the client terminal and the first transfer destination of the packet based on a transmission source of the packet and an arrival frequency of one or more packets having a same transmission source as the packet,
wherein the first rule is set in such a manner that a ratio of the one or more packets to be sent to the CPU increases as an arrival frequency of the one or more packets decreases.

16. The information processing system according to claim 15, wherein
the transmission source is identified by transmission source information included in a header of the packet.

17. The information processing system according to claim 15, wherein
the management unit is further configured to set, in the router, the second rule defining a second feature to be used for routing the packet transferred from the function circuit or the CPU and the second transfer destination of the packet.
